(19) United States
(12) Patent Application Publication
(10) Pub. No.: US 2007/0188681 A1
(43) Pub. Date: Aug. 16, 2007

(54) Liquid crystal display

(75) Inventors: Kuk Young Cho, Seongnam-Si (KR); Young Bee Chu, Suwon-Si (KR); Dong Cheol Kim, Suwon-Si (KR); Jeong Min Seo, Seongnam-Si (KR); Byung Woong Han, Namdong-Gu Incheon (KR)

Correspondence Address: F. Chau & Associates, LLC, 130 Woodbury Road, Woodbury, NY, 11797, US

(73) Assignee: Samsung Electronics Co., Ltd., Suwon-si (KR)

(21) Appl. No.: 11/542,535

(22) Filed: Oct. 3, 2006

(30) Foreign Application Priority Data
Feb. 13, 2006 (KR) 10-2006-0013595

(51) Int. Cl. G02F 1/1335

(52) U.S. Cl. 349/114

(57) ABSTRACT

A transflective sheet for a liquid crystal display includes a porous polyolefin-based polymer resin layer. The porous polyolefin-based polymer resin layer may comprise, for example, polyethylene, polypropylene or a combination thereof. Moreover, the porous polyolefin-based polymer resin layer may be manufactured through, for example, a dry or wet stretch process.

### CROSS REFERENCE TO RELATED APPLICATIONS

This application claims priority from Korean Patent Application No. 10-2006-0013595 filed on Feb. 13, 2006, the disclosure of which is hereby incorporated by reference herein in its entirety.

### BACKGROUND OF THE INVENTION

1. Technical Field

The present disclosure relates to a liquid crystal display, and more particularly, to a liquid crystal display which includes a transflective sheet having various transmissivities and reflectivities and which is capable of avoiding defective images caused by black spots and foreign substances.

2. Description of the Related Art

There are a wide range of applications in which a liquid crystal display (LCD) may be used because of its the lightweight, thin, low-power drive, full color and high resolution characteristics. For example, LCDs are used with computers, such as notebook computers, PDAs, telephones, TVs, audio/video devices, and the like. Moreover, an LCD is used to adjust an amount of light transmitted in accordance with image signals applied to a number of control switches arrayed in a matrix form and then display a desired image on an LCD panel.

A conventional LCD may be designed to display an image on one side thereof. However, in recent years, efforts and research have been made to implement a double-side display mode, for example, to display the same or different images on both sides of the LCD, in lieu of the above-mentioned one-side display fashion.

For example, the double-side LCD may be implemented into a dual folder type mobile communication terminal. FIGS. 1A and 1B show a dual folder type mobile communication terminal which includes a main liquid crystal display panel 1 used when the folder is opened and a sub liquid crystal display panel 2 used when the folder is closed.

As the liquid crystal display panels 1 and 2 are not self-luminescent, the panels may require an additional light source such as a backlight unit. To this end, a double-side LCD comprises a main liquid crystal display panel for displaying a main image thereon, a main backlight for supplying light to the main liquid crystal display panel, a sub liquid crystal display panel for displaying a sub image thereon, and a sub backlight for supplying light to the sub liquid crystal display panel. Each of the main and sub backlights includes a light source for emitting light, a light guide plate for changing the light path, a reflective plate for reflecting the light, an optical film for enhancing brightness, and a container for receiving the above components therein. However, certain difficulties may be encountered with the above-mentioned conventional double-side LCD such as, for example, increased manufacturing costs, increased thickness of the whole LCD due to the manufacture of the two backlight units and increased power consumption due to the operation of the two backlight units.

Recently, one solution for the aforementioned difficulties has been proposed, in which one light source and one light guide plate are used in the LCD to supply light in both directions. Here, the light source and the light guide plate are formed with a transflective sheet on one side thereof to allow light emitted from the light source to be transmitted and reflected, so that the light can be supplied to the main and sub liquid crystal display panels at the same time. The amount of light transmitted and reflected, for example, the amount of light supplied to the main and sub liquid crystal display panels, is determined by the characteristics of the transflective sheet. As the market for the double-side displays has expanded, the demand for a transflective sheet having various transmissivities and reflectivities has likewise increased.

In the past, a white foamed polyethylene terephthalate (PET) sheet or white foamed polycarbonate (PC) sheet has been employed as the transflective sheet. These conventional sheets are manufactured in such a manner that inorganic fine particles such as titanium oxide are added to a polyethylene terephthalate resin or polycarbonate resin, which are then foamed with each other As a result, black spots and foreign substances existing inside the inorganic particles or created during the above-mentioned conventional foaming process may lead to a defective backlight unit. Furthermore, these defective black spots may also be created on a display screen of a liquid crystal display when the liquid crystal display is driven.

Thus, there is a need for an LCD having a transflective sheet which prevents defective images caused by black spots and foreign substances from occurring.

### SUMMARY OF THE INVENTION

The present invention is conceived to solve the aforementioned problems in the prior art. An object of the present invention is to provide a liquid crystal display including a transflective sheet that has various transmissivity and reflectivity and can prevent defective images caused by black spots and foreign substances to thereby improve the reliability of the liquid crystal display.

According to an aspect of the present invention for achieving the object, there is provided a liquid crystal display, which comprises a transflective sheet having a porous polyolefin-based polymer resin layer. The porous polymer resin layer may comprise polyethylene or polypropylene. Further, the porous polymer resin layer may be manufactured through a dry or wet stretch process.

A white foamed polyethylene terephthalate (PET) layer may be further provided on the porous polymer resin layer. Alternatively, a white foamed polycarbonate (PC) layer is further provided on the porous polymer resin layer.

In addition, a contact prevention layer may be further provided on at least one surface of the porous polymer resin layer and include a plurality of beads and a coating film for holding the beads in place.

The liquid crystal display of the present invention may further comprise a light source, and a light guide plate including a first light emitting surface for emitting light incident from the light source in a first direction and a second light emitting surface for emitting the light in a second direction opposite to the first direction, wherein the transflective sheet is disposed on the second light emitting surface of the light guide plate.

The liquid crystal display may further comprise first optical sheets for enhancing brightness of light emitting in the first direction through the first light emitting surface of the light guide plate, and second optical sheets for enhancing brightness of light transmitting in the second direction through the transflective sheet.

In addition, the liquid crystal display may further comprise a first liquid crystal display panel formed on a side in the first direction to allow a first image to be displayed thereon, and a second liquid crystal display formed on the other side in the second direction to allow a second image to be displayed thereon.

### BRIEF DESCRIPTION OF THE DRAWINGS

Embodiments of the present invention can be understood in more detail from the following description taken in conjunction with the accompanying drawings, in which:

FIGS. 1A and 1B are perspective views showing a dual folder type mobile communication terminal;

FIG. 2 is a scanning electron microscope (SEM) photograph showing the surface of a transflective sheet according to an exemplary embodiment of the present invention;

FIG. 3 is a sectional view illustrating an example of a transflective sheet according to an exemplary embodiment of the present invention;

FIG. 4 is a flow chart illustrating a method of manufacturing a transflective sheet using a dry stretch process;

FIG. 5 is a flow chart illustrating a method of manufacturing a transflective sheet using a wet stretch process;

FIG. 6 is a schematic sectional view of a double-side backlight assembly including a transflective sheet of an exemplary embodiment the present invention; and

FIG. 7 is an exploded perspective view of a double-side liquid crystal display according to an exemplary embodiment of the present invention.

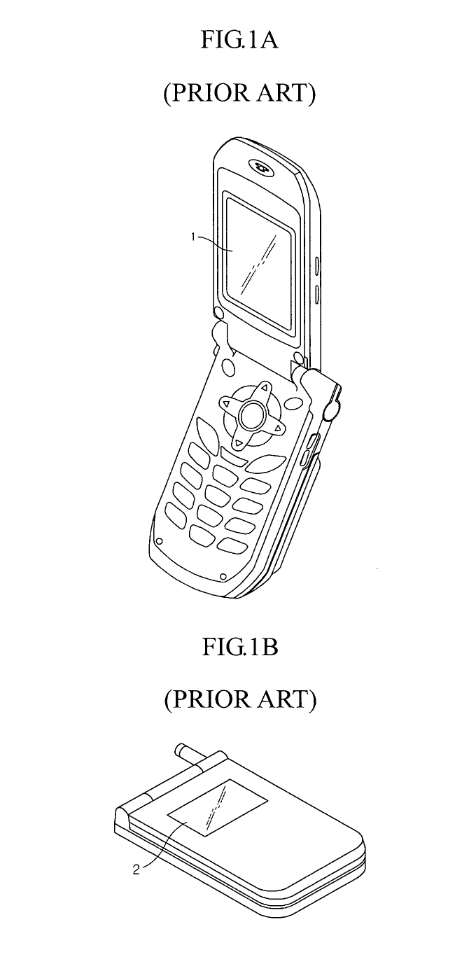

### DETAILED DESCRIPTION OF THE EXEMPLARY EMBODIMENTS

Hereinafter, a transflective sheet for a liquid crystal display (LCD) according to exemplary embodiments of the present invention will be described in detail with reference to the accompanying drawings.

The transflective sheet for an LCD according to exemplary embodiments of the present invention is characterized by including a porous polymer resin layer. The porous polymer resin can be readily fabricated into a sheet due to its mechanical properties and the fabricated sheet can have various transmissivities and reflectivities due to its suitable porosity. The transflective sheet can be manufactured through, for example, a dry or wet stretch process, which will be described later.

The transflective sheet reflects a part of incident light and transmits the other part of the incident light. To this end, fine pores in the porous polymer resin layer functions to reflect incident light. These fine pores are formed during the fabrication of the sheet, for example, during the stretch process. As the fine pores are contained in the porous polymer resin layer to reflect light, the transflective sheet of this embodiment does not require any additional additives for light reflection nor any additional foaming processes.

Moreover, due to the fine pores, the transflective sheet of this embodiment of the present invention reflects a part of light and transmits the remaining part of the light. The transmissivity and reflectivity of the sheet can be adjusted to control the amount of light supplied in both directions. Furthermore, the transmissivity and reflectivity of the transflective sheet containing a porous polymer resin layer can be controlled, for example, by adjusting its thickness or porosity. For example, as the thickness of the transflective sheet increases, its reflectivity may increase but its transmissivity may decrease.

The transflective sheet of this embodiment includes a porous polymer resin layer made of a polyolefin based resin which has high transparency and improved mechanical strength and improved resistance against light and heat emitted from a light source. The polyolefin includes, for example, a crystalline homopolymer, 2-stage polymer or copolymer; or a blend thereof by combining ethylene, propylene, 1-butene, 4-methyl-penthene-1, 1-hexene, 1-octene, vinyl acetate, methyl methacrylate or styrene. For example, in the present embodiment, polyethylene or polypropylene is used to form a porous polymer resin layer.

The transflective sheet of this embodiment can be formed by using, for example, polyethylene or polypropylene alone or in combination, depending on the physical properties required for the specific usage. Alternatively, if a plurality of different porous polymer resin layers are laminated to form a transflective sheet or a conventional white foamed polyethylene terephthalate is laminated with the transflective sheet of this embodiment of the present invention, a transflective sheet having various transmissivities and reflectivities may be obtained.

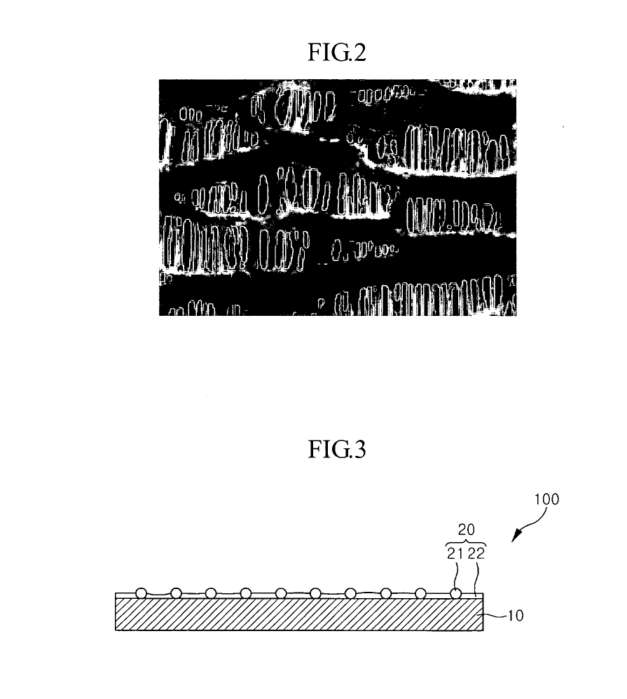

FIG. 2 is a SEM photograph showing a surface of a transflective sheet according to an exemplary embodiment of the present invention. It can be seen from FIG. 2 that the transflective sheet contains fine pores that in turn allow light to be reflected and transmitted. Further, it can be seen that there are no black spots and foreign substances, which may be caused by additional additives or a foaming process.

As illustrated in FIG. 3, the transflective sheet of this embodiment of the present invention may further comprise a contact prevention layer 20 formed on one or both surfaces of the porous polymer resin layer 10. The contact prevention layer 20 comprises a plurality of beads 21 and a coating film 22. The beads 21 are formed of fine particles with a particle size of about 3 to about 7 micrometers (μm) and then uniformly distributed over the surface(s). The coating film is made of, for example, a thermosetting or photo-curable resin and coated onto one or both surfaces of the porous polymer resin layer 10 in the form of a thin film such that it is cured by, for example, external heat or ultraviolet to hold the beads 21 in place.

In a case where the transflective sheet is applied to an LCD, such a contact prevention layer 20 prevents the transflective sheet from coming into close contact with other sheets disposed on both surfaces thereof. Thus, the degradation of display quality (e.g. a moire pattern), which may be caused when the plurality of sheets are brought into close contact with each other, can be avoided.

As described above, the transflective sheet having a porous polymer resin layer in accordance with exemplary embodiments of the present invention, has improved mechanical properties and has various transmissivities and reflectivities due to the fine pores contained therein. Further, as additional additives or foaming processes are not required in forming the transflective layer of exemplary embodiments of the present invention; defective images caused by the black spots and foreign substances can be prevented.

Hereinafter, a method of manufacturing a transflective sheet for an LCD according to an exemplary embodiment of the present invention will be described. As described above, the transflective sheet can be manufactured through a dry or wet stretch process.

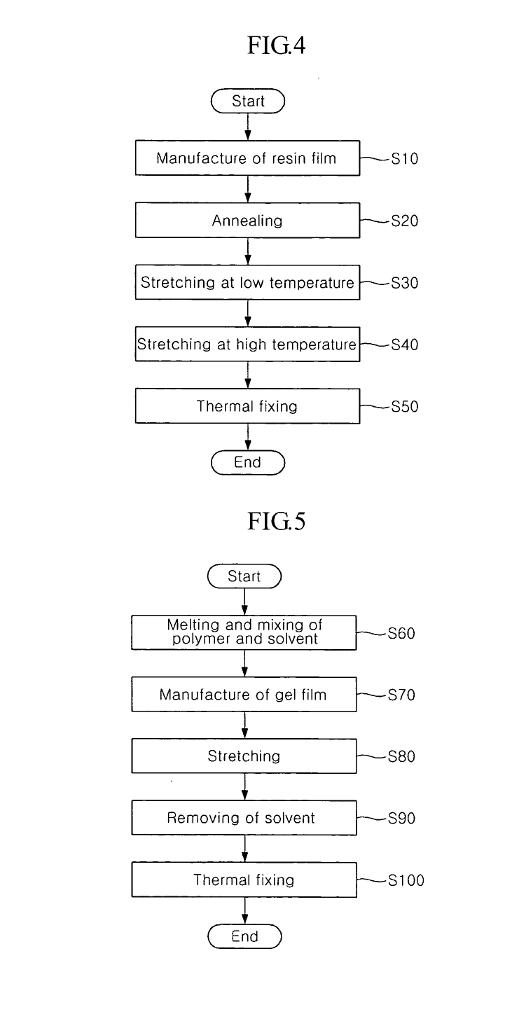

FIG. 4 is a flow diagram illustrating a method of manufacturing a transflective sheet through a dry stretch process.

Referring to FIG. 4, a resin film is first manufactured by extruding a desired polymer material through an extruder (S10). The resin film so manufactured is annealed in an oven at a temperature below the melting point of the polymer material to enhance its crystallinity and elasticity (S20). The annealed resin film is stretched along one or two axes at a first temperature below the room temperature using a roll or other expander to thereby form fine cracks therein (S30). Then, the resin film stretched at a lower temperature is further stretched along one or two axes at a second temperature relatively above the first temperature but below the melting point of the polymer to thereby form fine pores therein and to provide desired mechanical properties (S40). Thereafter, the resin film stretched at a higher temperature is thermally fixed under tension at a temperature below the melting point of the polymer for a certain period of time to thereby stabilize the fine pores (S50). Accordingly, a porous transflective sheet can be manufactured.

The aforementioned dry stretch process is performed in such a manner that a crystalline portion of a polymer is oriented toward a certain direction and a relatively weak amorphous portion of the polymer is destroyed through cold stretching to thereby form pores therein. Therefore, the above-mentioned process of this embodiment may provide a clean process which may readily produce a wide resin film using only a pure polymer without encountering the difficulties of conventional processes such as, for example, solvent contamination or the like.

FIG. 5 is a flow diagram illustrating a method of manufacturing a transflective sheet through a wet stretch process.

Referring to FIG. 5, a desired polymer and a solvent are first melted and mixed (S60). Here, the solvent is one which can sufficiently dissolve the polymer and may be an aliphatic solvent such as, for example, nonane, decane, undecane, dodecane, liquid paraffin, alicyclic hydrocarbon or the like. In addition, the polymer may be included, for example, from about 10 to about 50% by weight of the mixture of the polymer and the solvent.

In a case where the polymer content is less than about 10 wt. %, difficulties may be encountered in manufacturing the transflective sheet, due to, for example, a swelling and neck-in phenomena occurring during the manufacture of the film and the productivity of the manufacturing process may also be decreased. In a case where the polymer content is greater than about 50 wt. %, there may be another difficulty encountered in that the porosity of the transflective sheet may be reduced. The mixture of the polymer and solvent is extruded and cooled to fabricate a gel film (S70). In addition, a sequential or simultaneous biaxial stretching process is performed on the gel film, or the sequential and simultaneous biaxial stretching processes are performed on the gel film in a certain order (S80). Next, the solvent is removed from the stretched film (S90) and then dried and thermally fixed (S100) to manufacture a porous transflective sheet.

This wet stretch process can be used to uniformly control the size and shape of pores and also to control the porosity and physical properties by modifying the composition of the polymer or improving the process related to the solvent contents or solvent removal rate.

The method of manufacturing a transflective sheet according to this embodiment of the present invention is not limited to the aforementioned process. That is, some steps may be omitted or included or the order of the steps may be changed depending on the required final physical properties of the sheet.

The transflective sheet so manufactured has at least the following benefits. That is, the sheet can have various transmissivities and reflectivities by means of the fine pores formed during the stretch process. Therefore, additional additives for light reflection are not necessary and a foaming process may also be omitted. Thus, the occurrence of black spots and foreign substances can be prevented to reduce defective images.

Hereafter, a liquid crystal display (LCD) of an exemplary embodiment of the present invention will be described in greater detail.

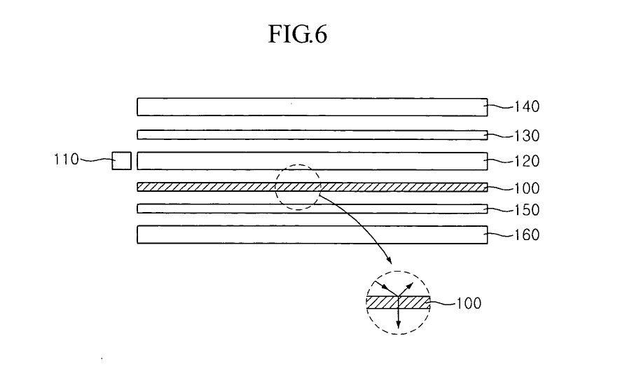

FIG. 6 is a schematic sectional view illustrating a double-side backlight assembly including a transflective sheet of an exemplary embodiment of the present invention.

Referring to FIG. 6, the double-side backlight assembly comprises a light source 110 for emitting light, a light guide plate 120 for changing an optical path, and a transflective sheet 100 for transmitting and reflecting light from the light guide plate 120 towards both directions. In addition, the double-side backlight assembly further comprises first and second optical sheets 130 and 150 for light diffusion and brightness enhancement. First and second liquid crystal display panels 140 and 160 are provided on outer surfaces of the optical sheets 130 and 150, respectively.

The light source 110 is disposed on one lateral side of the light guide plate 120 and emits light by means of an external driving voltage. In this embodiment, the light source 110 includes at least one light emitting diode. The light source 110 is not limited to the light emitting diode but may also employ, for example, a cold cathode fluorescence lamp (CCFL) in the form of an elongated cylinder.

The light guide plate 120 changes the optical path of light incident from the light source 110 to emit the light in both directions. To this end, the light guide plate 120 includes a first light emitting surface for directing the incident light from the light source 110 toward a first direction and a second light emitting surface for directing the incident light from the light source 110 toward a second direction. In this embodiment, the first direction is a direction towards the first liquid crystal display panel 140, whereas the second direction is a direction opposite to the first direction. The second light emitting surface may be formed in parallel with the first light emitting surface. In addition, the light guide plate 120 may further include a reflection pattern which is formed on the first or second light emitting surface to scatter and reflect the light incident on the first or second light emitting surface. Furthermore, the light guide plate 120 may further be formed with a prism pattern on the second light emitting surface thereof.

The transflective sheet 100 is formed on the second light emitting surface of the light guide plate 120. The transflective sheet 100 reflects a part of light emitted through the second light emitting surface and transmits the remaining part of the light. To this end, the transflective sheet 100 having a porous polymer resin layer is employed such that various transmissivities and reflectivities may be obtained for the transflective sheet 100 due to fine pores formed in the porous polymer resin layer. In addition, the transflective sheet 100 having a porous polymer resin layer does not require any additional additives or a foaming process, and thus, defective images caused by black spots and foreign substances can be prevented. The porous polymer resin layer may be made of, for example, polyethylene, polypropylene or a combination thereof.

The transflective sheet 100 may be formed by laminating different porous polymer resin layers with one another or may be formed by laminating together the transflective sheet with a conventional white foamed polyethylene terephthalate (PET) layer or white foamed polycarbonate (PC) layer.

In addition, the transflective sheet 100 may further comprise a contact prevention layer formed on one or both surfaces thereof. That is, the sheet comprises a plurality of uniformly distributed beads and a coating film fixing the beads to prevent the transflective sheet 100 from being brought into close contact with the light guide plate 120 or the second optical sheets 150. Accordingly, display defects such as a moire pattern or the like occurring when a plurality of sheets are brought into close contact with one another can be prevented.

The first optical sheets 130 are disposed on the first light emitting surface of the light guide plate 120 and serves to enhance the brightness of light emitting through the first light emitting surface in the first direction. That is, to enhance the brightness uniformity of light emitting in the first direction and the front brightness of light, the first optical sheets 130 may include a diffusion sheet for diffusing light or at least one prism sheet for collecting light.

The second optical sheets 150 are disposed on the second light emitting surface of the light guide plate 120 and serves to enhance the brightness of the light transmitting through the transflective sheet 100 among the light emitting through the second light emitting surface in the second direction. That is, to enhance the brightness uniformity of light emitted in the second direction and the front brightness of light, the second optical sheets 150 may include a diffusion sheet for diffusing light or at least one prism sheet for collecting light.

The second optical sheets 150 may be formed to have a surface area similar to those of the second light emitting surface and the transflective sheet 100 but may be changed into various forms depending on the size and position required by users. For example, the second optical sheets 150 may have a size corresponding to that of the second liquid crystal display panel 160 on which an image is displayed by using light transmitting through the second optical sheets 150.

The first liquid crystal display panel 140 allows images to be displayed thereon by using light transmitting through the first optical sheets 130, whereas the second liquid crystal display panel 160 allows images to be displayed thereon by using light transmitting through the second optical sheets 150.

Each of the first and second liquid crystal display panels 140 and 160 includes an upper substrate provided with a plurality of color filters, a lower substrate provided with a plurality of thin film transistors and coupled to face the upper substrate, and a liquid crystal sealed between the upper and lower substrates which are coupled with each other by means of a sealant. White light emitted from a backlight assembly passes through liquid crystal cells and the thin film transistors formed in the lower substrate are driven to orient the liquid crystal such that the transmittance of light can be adjusted. Then, the light transmits through the adjacent red, green and blue filters to display an image on the panels.

In this way, the double-side backlight assembly employs one light source, one light guide plate and a transflective sheet to emit light in two different directions. Thus, as a single light source is used to supply light in the two different directions, the thickness of the double-side backlight assembly can be decreased and the power consumption can also be reduced. Further, since a transflective sheet having a porous polymer resin layer is used therein, the sheet may have various transmissivities and reflectivities while avoiding defective images caused by black spots and foreign substances.

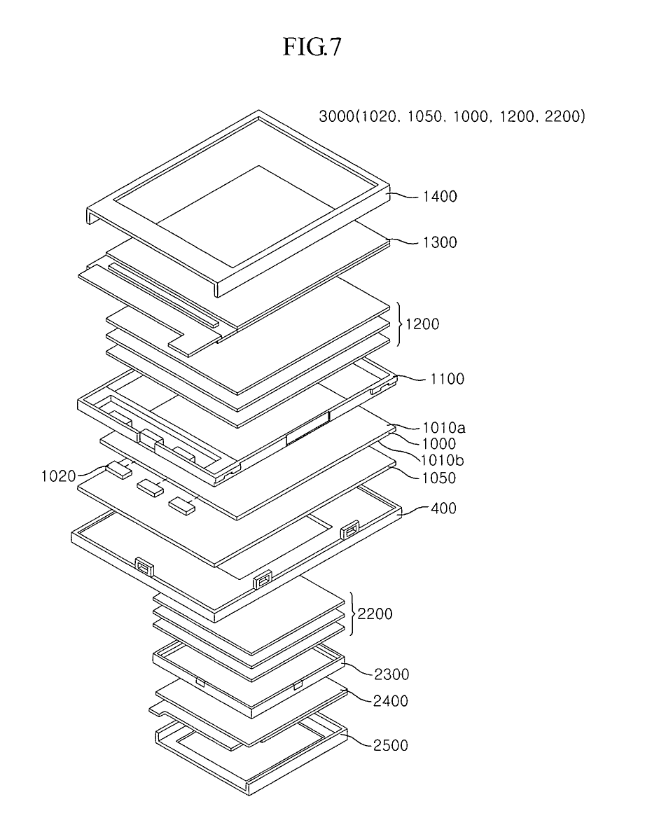

FIG. 7 is an exploded perspective view of a double-side liquid crystal display according to an exemplary embodiment of the present invention.

Referring to FIG. 7, the double-side liquid crystal display of this embodiment of the present invention comprises a main liquid crystal display panel 1300, a sub liquid crystal display panel 2400 and a double-side backlight assembly 3000.

The double-side backlight assembly 3000 includes a light source 1020 for emitting light, a light guide plate 1000 for changing an optical path of light, and a transflective sheet 1050. In addition, the double-side backlight assembly 3000 may further include first and second optical sheets 1200 and 2200.

The main liquid crystal display panel 1300 is provided on a first light emitting surface 1010a of the light guide plate 1000. Moreover, the main liquid crystal display panel receives light emitted in a first direction from the first light emitting surface 1010a of the light guide plate 1000 and transmitted through the first optical sheets 1200. The main liquid crystal display 1300 also allows a main image with information to be displayed thereon.

The sub liquid crystal display panel 2400 is provided on a second light emitting surface 1010b of the light guide plate 1000. Such a sub liquid crystal display panel 2400 receives light emitted in a second direction from the second light emitting surface 1010b of the light guide plate 1000 and transmitted through the second optical sheets 2200. The sub liquid crystal display panel 2400 allows a sub image with information to be displayed thereon.

Furthermore, first and second optical sheets 1200 and 2200 are provided between the main liquid crystal display panels 1300 and the light guide plate 1000 and between the sub liquid crystal display panels 2400 and the light guide plate 1000, respectively. In addition, the first optical sheets 1200 and the main liquid crystal display panel 1300 are received in a main mold frame 1100; and the aforementioned components, the light guide plate 1000 and the transflective sheet 1050 are received in a lower chassis. Further, the second optical sheets 2200 and the sub liquid crystal display panel 2400 are received in a sub mold frame 2300.

Moreover, a main chassis 1400 for preventing the main liquid crystal display panel 1300 from dislodging from the double-side backlight assembly and a sub chassis 2500 for preventing the sub liquid crystal display panel 2400 from dislodging from the double-side backlight assembly may be further provided.

A display area of the main liquid crystal display panel 1300 may be the same as that of the sub liquid crystal display panel 2400, but the exemplary embodiments of the present invention are not limited thereto. That is, the display area of the main liquid crystal display panel 1300 may be different from that of the sub liquid crystal display panel 2400. In this embodiment, the display area of the main liquid crystal display panel 1300 is set larger than that of the sub liquid crystal display panel 2400.

The double-side liquid crystal display so configured employs a single light source to supply light in both directions, and thus, the thickness and power consumption of the liquid crystal display can be reduced.

Furthermore, as this embodiment of the present invention employs a transflective sheet having a porous polymer resin layer, various transmissivities and reflectivities may be achieved to control the ratio of amount of light emitted in both directions. For example, to control the brightness ratio of the main and sub liquid crystal display panels to a ratio of about 70:30, the reflectivity of the transflective sheet can be controlled to about 60 to about 90% or the transmissivity of the sheet can be controlled to about 10 to about 40%. That is, the transflective sheet allows about 60 to about 90% of the light emitted from the light source to be emitted in the first direction and simultaneously about 10 to about 40% of the light to be emitted in the second direction. Thus, as the amount of light supplied to the main liquid crystal display panel is within a range of about 60 to about 90% of the total amount of light, the brightness of the main liquid crystal display panel can be relatively increased. In addition, as the amount of light supplied to the sub liquid crystal display panel is within a range of about 10 to about 40%, the brightness of the sub liquid crystal display panel can be improved as compared with a case where a light supply means is not provided. As the amount of light does not have to be larger when the sub liquid crystal display panel is used as a small auxiliary liquid crystal display panel, adequate brightness can be achieved with only about 10 to about 40% of the total amount of light.

In addition, as the transflective sheet of exemplary embodiments of the present invention does not cause black spots and foreign substances during the manufacture thereof, the occurrence of defective images caused by the black spots and foreign substance are prevented to thereby improve the reliability of the LCD.

Hereinafter, the exemplary embodiments present invention will be explained further in detail in connection with the examples set forth below.

### COMPARISON EXAMPLE

A double-side liquid crystal display with a size of about 2.22 inch is manufactured to include a main liquid crystal display panel, a sub liquid crystal display panel and a double-side backlight assembly. The double-side backlight assembly comprises a light source including six LEDs, a light guide plate, and a transflective sheet. The transflective sheet is made of a white foamed polyethylene terephthalate (PET).

### EXAMPLE 1

A double-side liquid crystal display with a size of about 2.22 inch is manufactured to include a main liquid crystal display panel, a sub liquid crystal display panel and a double-side backlight assembly. The double-side backlight assembly comprises a light source including six LEDs, a light guide plate, and a transflective sheet. The transflective sheet includes a porous polyolefin-based resin layer.

### EXAMPLE 2

A double-side liquid crystal display with a size of about 2.22 inch is manufactured to include a main liquid crystal display panel, a sub liquid crystal display panel and a double-side backlight assembly. The double-side backlight assembly comprises a light source including six LEDs, a light guide plate, and a transflective sheet. The transflective sheet is fabricated by laminating a transflective sheet including a porous polyolefin-based resin layer and a white foamed polyethylene terephthalate (PET) sheet.

In the examples and the comparison example, all the components except the transflective sheet are configured in the same way. The physical properties of the double-side liquid crystal displays are now compared with one another as set forth below.

The following table 1 shows comparison results of brightness in Comparison example, and Examples 1 and 2.

TABLE 1

| | | | Brightness | | Brightness | Total |
|---|---|---|---|---|---|---|
| | | Thickness | (mcd) | | ratio | brightness |
| Classification | Material | (μm) | Main | Sub | (main:sub) | (mcd) |
| Comparison | White | 60 | 3223 | 1308 | 71.1:28.9 | 4531 |
| example | foamed PET | | | | | |
| Example 1 | Porous | 25 | 2895 | 1795 | 61.7:38.3 | 4690 |
| | polyolefin | | | | | |
| Example 2 | White | 85 | 3463 | 1190 | 74.4:25.6 | 4653 |
| | foamed PET + Porous | | | | | |
| | Polyolefin | | | | | |

It can be seen from Table 1 that the total brightness in Examples 1 and 2 in accordance with exemplary embodiments of the present invention is relatively superior to that in Comparison example.

The following table 2 shows a measurement result of the number of defective images in one hundred samples when the double-side liquid crystal displays according to the Example 1 of the present invention and Comparison example are driven.

TABLE 2

| Classification | Material | Apparent defect rate |
|---|---|---|
| Comparison example | White foamed PET | 11/100 |
| Example 1 | Porous polyolefin | 4/100 |

It can be seen from Table 2 that Example 1 in accordance with an exemplary embodiment of the present invention exhibits a lesser apparent defect rate in comparison to Comparison example. In Comparison example, black spot defects are created on the screen due to black spots and foreign substances of inorganic particulates added in the white foamed polyethylene terephthalate (PET) or produced during the foaming process at a higher temperature. However, Example 1 in accordance with exemplary embodiments of the present invention exhibits a lesser apparent defect rate than the Comparison example and also does not exhibit black spot defects. As described above, as embodiments of the present invention employ a transflective sheet having a porous polymer resin layer, additional additives and/or a foaming process are not necessary. Therefore, with exemplary embodiments of the present invention, black spots and foreign substances are not produced, and thus, the black spot defects can also be prevented.

As described above, as embodiments of the present invention employ a single light source and a single light guide plate to supply light in two different directions, the thickness and power consumption of the liquid crystal display can be reduced. Further, as embodiments of the present invention employ a transflective sheet having a porous polymer resin layer, a liquid crystal display may have various transmissivities and reflectivities and also control the ratio of the amount of light emitted in both directions. Furthermore, defective images due to black spots and foreign substances can be avoided and the reliability of the liquid crystal display can be consequently improved.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A liquid crystal display, comprising a transflective sheet having a porous polyolefin-based polymer resin layer.

2. The liquid crystal display as claimed in claim 1, wherein the porous polymer resin layer comprises polyethylene or polypropylene.

3. The liquid crystal display as claimed in claim 2, wherein the porous polymer resin layer is manufactured through a dry or wet stretch process.

4. The liquid crystal display as claimed in claim 1, wherein a white foamed polyethylene terephthalate (PET) layer is further provided on the porous polymer resin layer.

5. The liquid crystal display as claimed in claim 1, wherein a white foamed polycarbonate (PC) layer is further provided on the porous polymer resin layer.

6. The liquid crystal display as claimed in claim 1, wherein a contact prevention layer is further provided on at least one surface of the porous polymer resin layer.

7. The liquid crystal display as claimed in claim 6, wherein the contact prevention layer includes a plurality of beads and a coating film for holding the beads in place.

8. The liquid crystal display as claimed in claim 1, further comprising:
a light source; and
a light guide plate including a first light emitting surface for emitting light incident from the light source in a first direction and a second light emitting surface for emitting the light in a second direction opposite to the first direction,
wherein the transflective sheet is disposed on the second light emitting surface of the light guide plate.

9. The liquid crystal display as claimed in claim 8, further comprising:
first optical sheets for enhancing brightness of light emitting in the first direction through the first light emitting surface of the light guide plate; and
second optical sheets for enhancing brightness of light transmitting in the second direction through the transflective sheet.

10. The liquid crystal display as claimed in claim 9, further comprising:
a first liquid crystal display panel formed on a side in the first direction to allow a first image to be displayed thereon; and
a second liquid crystal display formed on the other side in the second direction to allow a second image to be displayed thereon.
